(19) United States
(12) Patent Application Publication
(10) Pub. No.: US 2008/0233246 A1
(43) Pub. Date: Sep. 25, 2008

(54) Impregnated or Coated Tubular Cellulose-Based Food Casing

(76) Inventors: Klaus-Dieter Hammer, Mainz (DE); Herbert Gord, Ingelheim (DE); Jens Foegler, Taunusstein (DE); Michael Seelgen, Idstein (DE); Gert Bueker, Singhofen (DE)

Correspondence Address: PROPAT, L.L.C., 425-C SOUTH SHARON AMITY ROAD, CHARLOTTE, NC, 28211-2841, US

(21) Appl. No.: 11/996,785

(22) PCT Filed: Aug. 1, 2006
(86) PCT No.: PCT/EP2006/007587

§ 371 Date: Jan. 25, 2008

(30) Foreign Application Priority Data
Aug. 4, 2005 (DE) 10 2005 036 688.0

(51) Int. Cl. A22C 13/00; A23L 1/31

(52) U.S. Cl. 426/105; 428/34.8; 426/138

(57) ABSTRACT

The invention relates to a tubular cellulose-based food casing, the internal and/or external face of which is provided with an impregnation or coating made of blood albumin and/or a mixture of collagen fibers and collagen hydrolysate that improves cling of the casing to the food or renders the casing virtually resistant against cellulytic enzymes. The invention also relates to a method for producing such impregnated food casing and the use thereof as an artificial sausage casing.

The invention relates to a tubular cellulose-based food casing which is treated on the inside with an agent which increases the cling to the food, and/or on the outside with an agent which effects a cellulase resistance. The invention also relates to a method of producing the food casing thus modified and also to use thereof as artificial sausage casing.

Tubular cellulose-based casings having an impregnation or coating on the inside and/or outside are already known. By means of the impregnation or coating the cling between the inside of the casing and the outside of the food situated in the casing is adjusted according to requirements, for example increased or decreased compared with an unpretreated casing.

For instance, in DE-A 37 13 712 a casing made of fiber-reinforced cellulose is disclosed which is impregnated on the inside with a mixture of at least one adhesion component and at least two release components and as a result has particularly low cling to sausage emulsion. The adhesion component and at least one of the release components is firmly bound to the cellulose of the casing, whereas at least one further release component is not bound. The adhesion component is generally bound to the cellulose using a crosslinker, such as glyoxal or glutardialdehyde. It is preferably a plant or animal protein, chitosan, an aminoplast precondensate or a polyamine-polyamide-epichlorohydrin resin. The bound release component is preferably a chromium-fatty acid complex, a reactive silicone or a diketene having long fatty alkyl or aralkyl radicals. The unbound release component is, for example, perfluoroethylene, polyethylene, lecithin or a wax. By means of a coating, the handleability of the casing can also be improved, in such a manner that it may more readily be pushed onto the stuffing horn of the stuffing machine.

A fiber-reinforced food casing based on regenerated cellulose having a coating situated at least on the outside which increases the roughness in such a manner that the casing becomes more handleable is disclosed in EP-A 287 967. The coating comprises a water-insoluble cationic resin and additionally particles or fibers made of plastic or cellulose.

EP-A 100 056 relates to a cellulose fiber skin permeable to atmospheric oxygen, water vapor and smoke having a plastic coating on the outside by means of which it is resistant to the attack of cellulytically active enzymes. Edelschimmel [sausage-ripening mold], as used for flavor improvement of long-life sausages, releases cellulase and other cellulytic enzymes which decompose a cellulose casing with increasing storage time and make it fragile. The casing, at the end of the storage time, then may no longer be taken off from the sausage mix without tearing. During the attempts to remove individual pieces of the casing, damage to the sausage emulsion surface may occur, which the consumer rejects as “unappetizing”.

Sausage products are increasingly being sold in sliced form as slicers. Frequently the casing in this case is not taken off before slicing. The casing therefore must adhere strongly to the sausage emulsion such that it is not pushed off from the sausage slices during slicing, but nevertheless may be peeled off from the individual slices. Such a cling was unachievable with the adhesions impregnations known hitherto.

The object was therefore to provide a cellulose-based food casing which exhibits increased sausage meat cling. In addition, it is to be virtually unsusceptible to cellulytically active enzymes (cellulases) which can be formed by molds under unfavorable ripening conditions. In addition the casing is intended to be as permanently supple as possible.

These objects are achieved when blood albumin or a mixture of collagen fibers, in particular collagen fibrils and collagen hydrolyzates, is applied to the inside and/or outside of the casing.

The present invention accordingly relates to a food casing based on regenerated or precipitated cellulose which has on the inside and/or outside an impregnation or coating which comprises blood albumin or a mixture of collagen fibers and collagen hydrolyzate. The blood albumin can likewise be mixed with collagen fibers. The casing is preferably fiber reinforced. Particularly preferably, as fiber reinforcement, it contains a wet-strength fiber paper, especially a wet-strength hemp fiber paper.

The collagen hydrolyzate is obtained, for example, by acidic boiling or enzymatic hydrolysis of collagen. It generally has a molecular weight of about 3000 to 15 000. In warm water (80° C.) it is completely soluble, at least, colloidal solutions can be generated therefrom. In a preferred embodiment, the collagen hydrolyzate is a gelatin having a bloom number from 0 to 280, preferably having a bloom number from 0 to 50. A gelatin having a bloom number of 0 no longer forms a gel. The collagen hydrolyzate, as does also the blood albumin, penetrates deeply into the cellulose casing and makes it permanently soft and supple.

The impregnation or coating of the invention is scarcely extracted by washing under processing conditions conventional in practice. Should a particularly strong anchoring be desired, blood albumin, collagen fibers and collagen hydrolyzate can be firmly bound to the cellulose, that is to say by covalent bonds. The bonding is expediently achieved by low-molecular-weight compounds having 2 or more reactive groups which act as crosslinkers. Very suitable crosslinkers are, in particular, aliphatic or cycloaliphatic compounds having 2 or more carbaldehyde groups, such as glyoxal, glutaraldehyde, succinaldehyce, sugar dialdehydes, epoxidized linseed oils, dialkylketenes, citral or tannin. The crosslinkers are applied mixed together with the remaining components of the impregnation or coating. The heat supplied during drying of the casings is generally sufficient to achieve complete crosslinking. Other agents for bonding the components of the impregnation or coating to the cellulose are usable in principle, for example irradiation with high-energy radiation, such as UV radiation or gamma radiation.

The collagen fibers or collagen fibrils comprise polypeptide chains each having about 1000 amino acid long sections. In each case 3 of these chains form one triple helix. The fibers can be up to about 250 μm thick. They generally have a length of up to 40 mm, preferably from about 0.01 to 25 mm. In a 5% strength aqueous sodium chloride solution at 15° C., the collagen fibers are virtually insoluble. The fibers are generally produced from the hide tissue of mammals, in particular from cattle or hogs, by treatment with acid or alkali.

The amount of impregnating substances should be between 80 and 180 mg/m², preferably between 100 and 150 g/m². Crosslinkers, such as glyoxal, are expediently present therein in a fraction of about 2 to 10% by weight, preferably 3 to 6% by weight, in each case based on the weight of the protein component (blood albumin, mixture of blood albumin and collagen fibers, mixture of gelatin an collagen fibers).

The cellulose-based food casing of the invention generally has a dry weight of about 70 to 150 g/m², preferably from 75 to 120 g/m². It preferably contains a reinforcement made of a wet-strength fiber paper, in particular a wet-strength hemp fiber paper. The paper generally has a weight of about 12 to 28 g/m², preferably from 15 to 25 g/m².

The optionally fiber-reinforced cellulose casing can be produced by the viscose or NMMO method. In the viscose method, first a strip of the fiber paper is shaped to front a tube having overlapping longitudinal edges, for example using a shaping shoulder. The fiber paper tube is then coated with viscose from the outside, from the inside or from both sides. The coated tube then passes into an acidic precipitation bath in which the cellulose xanthogenate present in the viscose is regenerated to form cellulose. Subsequently the gel tube passes further through a plurality of wash baths, optionally also a plasticizer bath. In the plasticizer bath there is generally situated an aqueous solution of a secondary plasticizer, such as glycerol.

In the NMMO method, instead of viscose, use is made of a solution of cellulose in N-methylmorpholine N-oxide (NMMO) monohydrate. After the coating, the gel tube passes through a precipitation bath in which there is situated a dilute aqueous NMMO solution. Subsequently, in a similar manner to the viscose method, it is passed through a plurality of wash baths until NMMO is virtually no longer detectable. Here also the tube can additionally be passed through a bath which contains an aqueous solution of a secondary plasticizer. The fiber-reinforced tube produced by the viscose method or the NMMO method in the manner described has no visible seam. It is therefore, in the context of the present invention, also termed “seamless”. The diameter, that is to say the nominal caliber of the tube, is generally 20 to 180 mm, preferably 35 to 150 mm.

The viscose, as also the NMMO/cellulose solution, used for coating the fiber reinforcement can additionally contain additives. These are, for example, polyvinyl-pyrrolidones and/or alginic acid and/or alginate which simultaneously act as non-extractable (“primary”) plasticizers.

The impregnation of the cellulose hydrate food casing with the blood albumin or the mixture of collagen fibers and collagen hydrolyzate can proceed by methods which are known per se to those skilled in the art. In order to coat the inside, for example a corresponding solution or dispersion can be charged into the interior and be kept stationary in a continuously newly formed loop (what is termed slug coating). For impregnation or coating of the outside, the solution or dispersion can be applied to the laid-flat tube using a roller applicator. The impregnation should proceed in each case when the cellulose hydrate casing is still in the gel state, that is to say before it is dried for the first time.

The aqueous solutions or dispersions used for impregnating or coating the inside or outside generally contain 2 to 20% by weight, preferably 3 to 6% by weight, of nornaquecus components.

In addition to the impregnation or coating containing blood albumin or collagen fibers and collagen hydrolyzate, the food casing of the invention can have further impregnations and/or coatings on the inside or outside. If only the inside is provided with the adhesive impregnation containing blood albumin or collagen fibers and collagen hydrolyzate, the outside is expediently fungicidally impregnated. This is particularly important when the casing is to be used for producing (nonmold-ripened) long-life sausage. In another embodiment, on the outside, there can be situated a coating which is substantially impermeable to water vapor and/or oxygen, for example a PVDC coating. The casing of the invention can finally also be impregnated with liquid smoke, which, during storage or ripening of the sausage, diffuses into the sausage emulsion and gives this a smoked flavor, smoked color and/or smoked aroma.

The casing of the invention is suitable as artificial sausage casing, in particular for scalded-emulsion sausage or long-life sausage, such as salami. Sausages in a casing having an outer impregnation according to the invention exhibit no change even after storage for many months. This applies even for mold-ripened long-life sausages. In the case of these sausages, no damage to the cellulose by cellulitically active enzymes (cellulases) which were formed by the molds were observed. Casings which are impregnated internally and externally in the manner described exhibit the desired cling to the sausage emulsion and simultaneously a high resistance to cellulases.

The examples hereinafter serve to illustrate the invention. Percentages therein are percentages by weight unless stated otherwise or immediately clear from the context.

### EXAMPLE 1

A fiber gel tube of caliber 105, after it left the glycerol vat, was impregnated internally with an aqueous solution which contained
4% blood plasma protein (75 PSC—Spraydried Porcine-Plasmapowder from VEOS, B-8750 Zwevezele, Belgium)
3% gly(oxal (based on the blood plasma protein) and
3% glycerol.

The gel tube was dried to a moisture content of 8 to 12% as customary between 2 pinch-roll pairs in the inflated state using hot air. The protein application rate was 120 mg/m². The tube was moistened to 16 to 18% with water, shirred and stuffed with meat sausage emulsion. The casing adhered very firmly and uniformly to the sausage surface, in such a manner that it could be cut into slices without detaching from the emulsion.

### EXAMPLE 2

An externally viscosed fiber gel tube of caliber 75, after it left the glycerol vat, was impregnated on the inside with a 3% strength aqueous solution of a mixture of

| | |
|---|---|
| 60 parts by weight | of collagen fibers, |
| 40 parts by weight | of collagen hydrolyzate (a |
| | 20% strength aqueous solution |
| | of the collagen hydrolyzate, |
| | at 20° C., had a dynamic |
| | viscosity of 25 ± 5 mPa · s) |
| 4 parts by weight | of glyoxal and |
| 3 parts by weight | of glycerol. |

The tube was dried to a moisture content of 10 to 12% as customary between two pinch-roll pairs in the inflated state using hot air. Thereafter it was moistened to 16 to 18% and shirred. Some shirred sticks were stuffed with meat sausage emulsion, others with long-life sausage emulsion. After scalding, smoking and cooling the meat sausage, the casing adhered so firmly that it did not detach even in places. The cling in long-life sausage, after a ripening period of 4 weeks was 0.5% above the hitherto highest cling with conventional impregnations, that is to say at 3.0 instead of 2.5 (for externally viscosed fiber skins; rating scale from 1 to 5).

### EXAMPLE 3

A cellulose hydrate gel tube (viscose distribution: 60% interior, 40% exterior) was produced which was reinforced with a fiber paper insert, and, after it left the glycerol vat, was laid flat and then, on the outside thereof, an aqueous solution having the following components was applied using a roller applicator:
4% blood albumin (®Vepro 75 PSC)
3% glyoxal (the fraction is based on the weight of the albumin) and
3% glycerol

Before the dryer inlet, then a conventional polyamine-polyamide-epichlorohydrin anchoring solution was introduced into the interior of the tube. The tube was then dried with hot air in a manner known per se in the inflated state between two pinch-roll pairs until it had a moisture content of about 8 to 12%. Subsequently it was internally coated with a polyvinylidene chloride (PVDC) dispersion. The tube obtained in this manner was soft and supple.

### EXAMPLE 4

A gel tube with cellulose hydrate having a fiber paper reinforcement, as specified in more detail in example 3, was impregnated on the outside using a roller applicator using a solution of the composition mentioned in example 3. The tube was thereafter provided on the inside with a conventional adhesive impregnation. This consisted of 40% casein, glyoxal and ®Softenol. After drying, moistening and shirring, the material was very supple and cellulase-resistant.

Shirred sticks from said material were stuffed with long-life sausage emulsion. Even after the sausages were ripened for several months, the casing was not damaged by the action of cellulases. In addition, it was readily peeled off, that is to say it did not tear during peeling.

1. A food casing comprising regenerated or precipitated cellulose which has on the inside and/or outside an impregnation or coating which comprises protein component(s) selected from blood albumin, a mixture of blood albumin and collagen fibers and/or a mixture of collagen fibers and collagen hydrolyzate.

2. The food casing as claimed in claim 1, wherein the impregnation or coating comprises a mixture of blood albumin and collagen fibers.

3. The food casing as claimed in claim 1, wherein the easing is fiber reinforced.

4. The food casing as claimed in claim 1, wherein the collagen hydrolyzate is a gelatin having a bloom number of less than 280.

5. The food casing as claimed in claim 1, wherein the collagen fibers have a length of less than 40 mm.

6. The food casing as claimed in claim 1, wherein the blood albumin, the collagen fibers and the collagen hydrolyzate are bound to the cellulose by covalent bonds.

7. The food casing as claimed in claim 6, wherein the bonding between the blood albumin, the collagen fibers, the collagen hydrolyzate and the cellulose is effected by low-molecular-weight crosslinkers having 2 or more reactive groups.

8. The food casing as claimed in claim 1, wherein the amount of blood albumin or of the mixture of collagen fibers and collagen hydrolyzate is between 80 and 180 mg/m².

9. The food casing as claimed in claim 1, wherein the fraction of crosslinker is 2 to 10% by weight, based on the weight of the protein component(s).

10. A method of producing the food casing as claimed in claim 1, which comprises the following steps:
providing a food casing based on regenerated or precipitated cellulose,
applying an aqueous preparation which comprises blood albumin or a mixture of collagen fibers and collagen hydrolyzate to one or both sides of the food casing and
drying the food casing.

11. The method as claimed in claim 10, said method further comprising adding at least one low-molecular-weight crosslinker to the aqueous preparation.

12. The method as claimed in claim 10, said method further comprising adding collagen fibers to the blood albumin.

13. Artificial sausage casing comprising food casing as claimed in claim 1.

14. The food casing as claimed in claim 3, wherein the casing is fiber reinforced with a wet-strength fiber paper.

15. The food casing as claimed in claim 3, wherein the casing is fiber reinforced with a wet-strength hemp fiber paper.

16. The food casing as claimed in claim 4, wherein the collagen hydrolyzate is a gelatin having a bloom number of from 0 to 50.

17. The food casing as claimed in claim 5, wherein the collagen fibers have a length of from 0.01 to 25 mm.

18. The food casing as claimed in claim 7, wherein the bonding between the blood albumin, the collagen fibers, the collagen hydrolyzate and the cellulose is effected by aliphatic or cycloaliphatic compounds having 2 or more carbaldehyde groups.

19. The food casing as claimed in claim 8, wherein the amount of blood albumin or of the mixture of collagen fibers and collagen hydrolyzate is between 100 and 150 g/m².

20. The food casing as claimed in claim 9, wherein the fraction of crosslinker is 3 to 6% by weight, based on the weight of the protein component(s).

21. A method of producing the food casing as claimed in claim 10, wherein the regenerated or precipitated cellulose is in the gel state.

22. Scalded-emulsion sausage or long-life sausage comprising food casing as claimed in claim 1.

23. Salami comprising food casing as claimed in claim 1.
